(19) United States
(12) Patent Application Publication
(10) Pub. No.: US 2026/0126917 A1
(43) Pub. Date: May 7, 2026

(54) SELECTIVELY RETIRING BLOCKS USING BEC AND CFBIT

(71) Applicant: Micron Technology, Inc., Boise, ID (US)

(72) Inventors: Hwei Ean Lim, Singapore (SG); Yuan Jun Teng, Singapore (SG); Yee Yang Tay, Singapore (SG); Tjiu Karuna Bakti Sudarsono, Singapore (SG)

(21) Appl. No.: 18/938,920

(22) Filed: Nov. 6, 2024

(51) Int. Cl. G06F 3/06

(52) U.S. Cl. CPC G06F 3/0619; G06F 3/064; G06F 3/0653; G06F 3/0689

(57) ABSTRACT

This disclosure is directed to a memory device that intelligently marks bad blocks. The memory device detects an uncorrectable error in a portion of a block stripe (BS) read from a memory device. The memory device determines whether the uncorrectable error in the portion of the BS resulted from an extrinsic defect of the memory device or a condition associated with the memory device and, in response to determining whether the uncorrectable error in the portion of the BS resulted from an extrinsic defect of the memory device or the condition associated with the memory device, selectively marks the portion of the BS as a bad block.

### TECHNICAL FIELD

Examples of the disclosure relate generally to memory sub-systems and, more specifically, to marking bad blocks in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various examples of the disclosure. The drawings, however, should not be taken to limit the disclosure to the specific examples, but are for explanation and understanding only.

FIG. 1 is a block diagram illustrating an example computing system that includes a memory sub-system, in accordance with some examples.

FIG. 2 is a block diagram of a bad block identification component, in accordance with some examples.

FIG. 3 illustrates a diagram of different velocity areas generated by the bad block identification component, in accordance with some examples.

FIG. 4 is a flow diagram of an example method to identify bad blocks, in accordance with some examples.

FIG. 5 is a block diagram of an example computer system in which examples of the present disclosure may operate.

### DETAILED DESCRIPTION

The present disclosure is directed to a memory sub-system that intelligently marks bad blocks in a block stripe (BS). Specifically, the memory sub-system controller can detect an uncorrectable error in a BS, such as a Redundant Array of Independent NAND (RAIN) stripe. In such cases, the memory sub-system controller can determine whether the uncorrectable error corresponds to an extrinsic defect, such as a physical defect of the memory sub-system or some other condition, such as an extreme temperature condition. If the uncorrectable error is determined to be the result of the physical defect, the block containing the uncorrectable error is marked as bad; otherwise the block is not marked as bad. To make this determination, the memory sub-system controller can determine whether mean or median of bit error counts (BECs) of all the correctable blocks in the same BS is above or below a threshold. If the mean or median of the BECs is above the threshold, the memory sub-system controller can further check whether the CFBit distribution of the portion containing the uncorrectable error corresponds to an expected distribution. The portion containing the uncorrectable error is then marked bad in response to determining that the CFbit distribution fails to correspond to the expected distribution. Otherwise, the memory sub-system controller determines that the error does not result from the extrinsic defect and may be the result of some other condition and prevents marking the block as bad.

In this way, rather than always marking blocks as bad when certain data recovery operations are performed that identify uncorrectable errors, a dynamic approach is utilized. The dynamic approach only marks blocks as bad if they are likely associated with extrinsic defects and are not usable. The dynamic approach avoids marking blocks that can continue to be used to reliably store data even when error correction operations (e.g., data recovery operations) identify uncorrectable errors in such blocks. This approach reduces the number of blocks marked as bad and avoids unnecessarily reducing the pool of blocks available for programming, which can improve or reduce the write amplification of the memory sub-system and improve the overall operations of the memory sub-system.

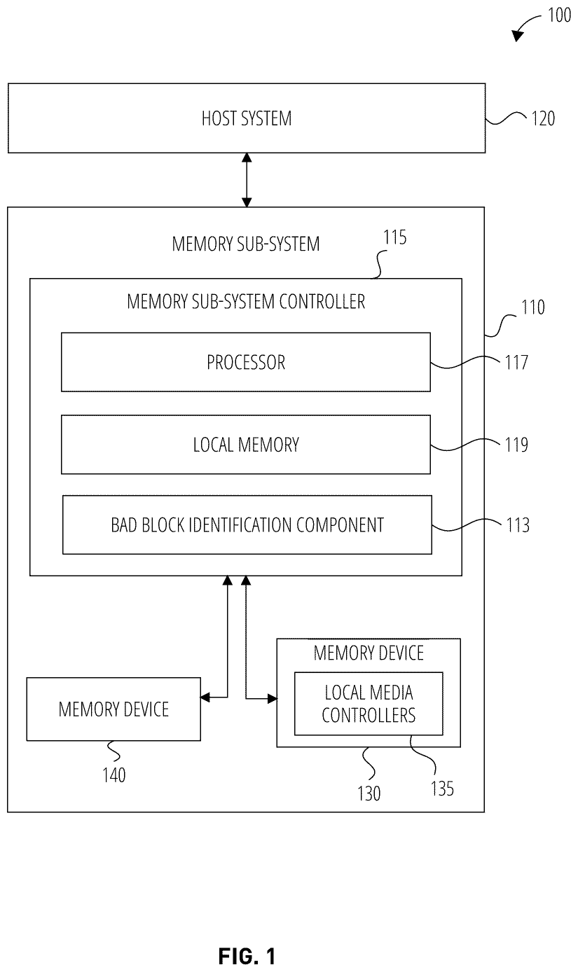

A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write command, read command, erase command) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”

A host request can include logical address information (e.g., logical block address (LBA), namespace) for the host data, which is the location the host system associates with the host data and a particular zone in which to store or access the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

The memory sub-system can initiate media management operations, such as a write operation, on host data that is stored on a memory device. For example, firmware of the memory sub-system may re-write previously written host data from a location of a memory device to a new location as part of garbage collection (GC) management operations. The data that is re-written, for example as initiated by the firmware, is hereinafter referred to as “GC data.”

“User data” hereinafter generally refers to host data and GC data. “System data” hereinafter refers to data that is created and/or maintained by the memory sub-system for performing operations in response to host requests and for media management. Examples of system data include, and are not limited to, system tables (e.g., logical-to-physical memory address mapping table, also referred to herein as a logital-to-physical (L2P) table, data from logging, scratch pad data, and so forth).

A memory device can be a non-volatile memory device. A non-volatile memory device is a package of one or more die. Each die can be comprised of one or more planes. For some types of non-volatile memory devices (e.g., AND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are a raw memory device combined with a local embedded controller for memory management within the same memory device package. The memory device can be divided into one or more zones where each zone is associated with a different set of host data or user data or application.

Certain memory devices, such as NAND-type memory devices, comprise one or more blocks, (e.g., multiple blocks), with each of those blocks comprising multiple memory cells. For instance, a memory device can comprise multiple pages (also referred to as word lines (WLs)), with each page comprising a subset of memory cells of the memory device. A threshold voltage (VT) of a memory cell (of a block) can be the voltage at which the floating gate (e.g., NAND transistor), implementing the memory cell, turns on and conducts (e.g., to a bit line coupled to the memory cell). Generally, writing data to such memory devices involves programming (by way of a program operation) the memory devices at the page level of a block, and erasing data from such memory devices involves erasing the memory devices at the block level (e.g., page level erasure of data is not possible).

The conventional approach to error recovery in NAND flash memory systems presents several inefficiencies and resource wastages, particularly in handling grown bad blocks (GBBs) under High Temperature Data Retention (HTDR) and extreme temperature (XTEMP) conditions. Traditional RAIN techniques are limited in their ability to recover from multiple codeword (CW) failures within a stripe, leading to potential misclassification of reusable blocks as bad. This misclassification can be problematic during HTDR/XTEMP conditions, where the intrinsic behavior of NAND, known as the shallow valley effect, frequently causes GBBs. The current Read Error Handling (REH) flow often marks these blocks as bad, even when they could be refreshed and reused, resulting in an unnecessary reduction of the spare block pool. The advanced TurboRAIN technique, while capable of recovering multiple CW failures, is underutilized due to its high latency and placement as a last resort in the REH flow. This low utilization represents a missed opportunity for more efficient error recovery and block management.

The current approach of marking all blocks recovered by RAIN as bad, including those exhibiting shallow valleys due to HTDR and XTEMP conditions, leads to a diminishment of the spare block pool. This reduction in available spare blocks can cause the firmware to disregard host commands to generate additional spares and can adversely impact solid state drive (SSD) performance. Moreover, the inability to distinguish between intrinsic and extrinsic NAND failures for each marked GBB further compounds the issue, as potentially reusable blocks are prematurely retired. In extreme cases, such as when a large number of blocks exhibit elevated Bit Error Count (BEC) and shallow valleys post-stress, current systems may mark all of them as GBBs. This can lead to critical situations where the SSD enters WRITEPROTECT mode, preventing further write operations and effectively rendering the drive non-functional for regular data storage. The depletion of the spare blocks pool not only limits the firmware's ability to handle host commands but also compromises overall SSD reliability and performance. This inefficient management of GBBs and spare blocks represents a significant waste of resources, as usable storage capacity is unnecessarily reduced, and SSD performance is compromised. The current approach fails to strike a balance between ensuring data integrity and maintaining optimal SSD functionality, particularly under challenging environmental conditions.

The disclosed techniques address these challenges by providing a memory controller that intelligently marks bad blocks. Specifically, the disclosed memory controller can detect an uncorrectable error in a BS, such as a RAIN stripe. In such cases, the memory controller can determine whether the uncorrectable error corresponds to an extrinsic defect, such as a physical defect of the memory sub-system or some other condition, such as an extreme temperature condition. If the uncorrectable error is determined to be the result of the physical defect, the block containing the uncorrectable error is marked as bad; otherwise the block is not marked as bad. To make this determination, the memory controller can determine whether mean or median of BECs of all the correctable blocks in the same BS is above or below a threshold. If the mean or median of the BECs is above the threshold, the memory controller can further check whether the CFBit distribution of the portion containing the uncorrectable error corresponds to an expected distribution. The portion containing the uncorrectable error is then marked bad in response to determining that the CFbit distribution fails to correspond to the expected distribution. Otherwise, the memory controller determines that the error does not result from the extrinsic defect and may be the result of some other condition and prevents marking the block as bad. This approach reduces the number of blocks marked as bad and avoids unnecessarily reducing the pool of blocks available for programming, which can improve or reduce the write amplification of the memory sub-system and improves the overall operations of the memory sub-system.

The disclosed techniques can be helpful in memory sub-systems, such as SSDs, that are used in data centers, data centers with artificial intelligence (AI) applications and systems, automotive applications, client personal computers, mobile devices, and so forth. The disclosed techniques particularly improve performance of operating AI applications on any such devices and systems that operate in high temperature conditions.

In some examples, the techniques described herein relate to a system including a memory device and a processing device, operatively coupled to the memory device. The processing device detects an uncorrectable error in a portion of a BS read from the memory device. The processing device determines whether the uncorrectable error in the portion of the BS resulted from an extrinsic defect of the memory device or a condition associated with the memory device and, in response to determining whether the uncorrectable error in the portion of the BS resulted from an extrinsic defect of the memory device or the condition associated with the memory device, selectively marks the portion of the BS as a bad block. The portion can include an individual block of a plurality of blocks of the BS.

The processing device determines that the uncorrectable error in the portion resulted from the extrinsic defect of the memory device. The processing device, in response to determining that the uncorrectable error in the portion resulted from the extrinsic defect of the memory device, marks the portion of the BS as the bad block to prevent subsequently received write operations from being performed on the portion of the BS. The processing device can determine that the uncorrectable error in the portion resulted from the condition associated with the memory device and, in response to determining that the uncorrectable error in the portion resulted from the condition associated with the memory device, prevents marking the portion of the BS as the bad block to allow subsequently received write operations to be performed on the portion of the BS. The condition can include exposure of the memory device to a temperature that transgresses a threshold operating temperature of the memory device.

The processing device can receive a request to read the BS from the memory device. The processing device, in response to receiving the request to read the BS from the memory device, detects one or more errors in the BS and performs a data recovery process to correct the one or more errors in the BS. The processing device detects the uncorrectable portion in response to the data recovery process. The data recovery process can include a RAIN operation and/or turbo RAIN (or TurboRAIN) operation.

The processing device can identify a set of portions of the BS that passed the data recovery process. The processing device obtains a BEC for each portion in the set of portions of the BS and computes a statistical measure of the obtained BEC of each portion in the set of portions of the BS. The statistical measure can include a mean or median. The processing device compares the statistical measure to a threshold value and, in response to determining that the statistical measure fails to transgress the threshold value, marks the portion including the uncorrectable error as the bad block.

In some examples, the processing device compares the statistical measure to a threshold value. The processing device, in response to determining that the statistical measure transgresses the threshold value, determines whether to prevent the portion from being marked as the bad block. The portion can be prevented from being marked as a bad block in response to checking a distribution of programmed bits of information in at least the portion. The processing device obtains CFBit values associated with different storage levels of the at least the portion of the BS and determines whether each of the obtained CFBit values is evenly distributed. The processing device, in response to determining that each of the obtained CFBit values is evenly distributed, prevents the portion of the BS from being marked as the bad block. The processing device, in response to determining that each of the obtained CFBit values is unevenly distributed, marks the portion of the BS as the bad block.

In some cases, the processing device can obtain a first CFbit value associated with a first storage level. The processing device computes a first distribution value based on the first CFbit value, the first storage level, and a total number of bits distributed in the at least the portion of the BS, thereby obtaining a second CFbit value associated with a second storage level. The processing device computes a second distribution value based on the second CFbit value, the second storage level, and the total number of bits distributed in the at least the portion of the BS. The processing device determines whether a plot of the first and second distribution values corresponds to an expected plot and, in response to determining that the plot of the first and second distribution values corresponds to the expected plot, prevents the portion of the BS from being marked as the bad block. Each of the different storage levels can correspond to a different threshold voltage applied to the portion of the BS to read data stored in the portion of the BS, such as in a tri-level cell (TLC) and/or quad-level cell (QLC) block of the memory device.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing system 100 that includes a memory sub-system 110, in accordance with some examples. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some examples, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, single level cells (SLCs), can store one bit per cell. Other types of memory cells, such as multi-level cells (MLCs), TLCs, QLCs, and penta-level cells (PLCs), can store multiple bits per cell. In some examples, each of the memory devices 130, 140 can include one or more arrays of memory cells such as SLCs, MLCs, TLCs, QLCs, or any combination of such. In some examples, a particular memory device can include an SLC portion, and an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks or BSs. As used herein, a block comprising SLCs can be referred to as a SLC block, a block comprising MLCs can be referred to as a MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data at the memory devices 130, 140 and other such operations. The memory sub-system controller 115 can include hardware such as one or more integrated circuits and/or discrete components, a buffer memory, or a combination thereof. The hardware can include digital circuitry with dedicated (e.g., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some examples, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another example, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, GC operations, error detection and ECC operations, encryption operations, caching operations, and address translations between a logical address (e.g., LBA, namespace) and a physical memory address (e.g., physical block address) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some examples, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some examples, the memory device 130 includes local media controllers 135 that operate in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some examples, a memory device 130 is a managed memory device, which is a raw memory device combined with a local controller (e.g., local media controller 135) for media management within the same memory device package. An example of a managed memory device is a managed NAND (MNAND) device.

The memory sub-system controller 115 includes a bad block identification component 113 that enables or facilitates the memory sub-system controller 115 to dynamically mark blocks as bad blocks. Specifically, the bad block identification component 113 can detect an uncorrectable error in a portion of a BS read from a memory device 130. The memory sub-system controller 115 determines whether the uncorrectable error in the portion of the BS resulted from an extrinsic defect of the memory device 130 or a condition associated with the memory device 130 and, in response to determining whether the uncorrectable error in the portion of the BS resulted from an extrinsic defect of the memory device 130 or the condition associated with the memory device 130, selectively marks the portion of the BS as a bad block. Any discussion with respect to the memory device 130 can similarly be applied to the memory device 140 alone or in combination.

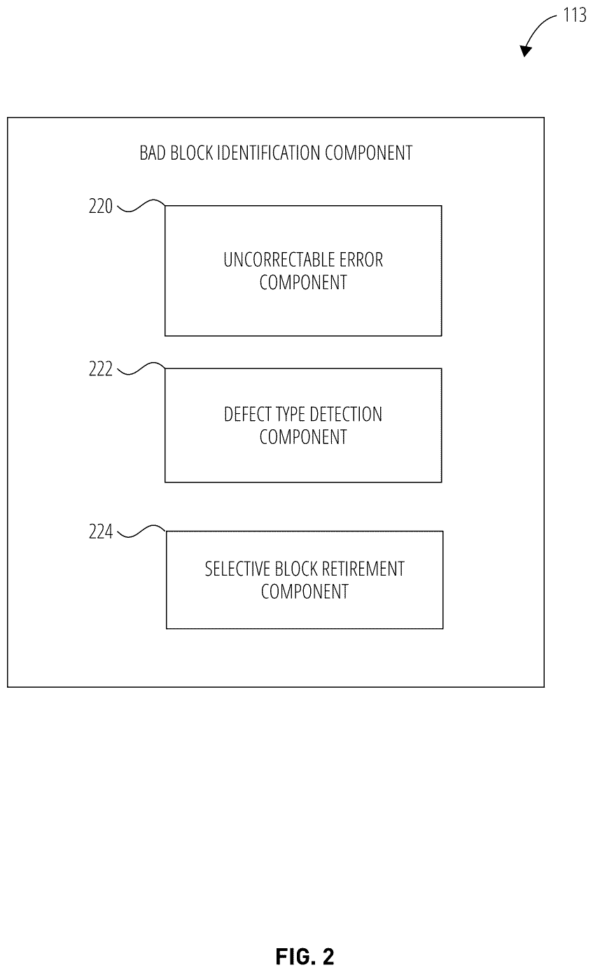

FIG. 2 is a block diagram of a bad block identification component 113, in accordance with some examples. The bad block identification component 113 can include an uncorrectable error component 220, a defect type detection component 222, and a selective block retirement component 224. While the below discussion pertains to BSs, similar techniques are applicable to any other portion of storage.

The uncorrectable error component 220 can monitor read operations performed by the memory sub-system controller 115. The uncorrectable error component 220 can determine when a BS that is read from the memory device 130 includes errors. The uncorrectable error component 220 can apply one or more data recovery processes, such as RAIN or turbo RAIN to the BS in response to determining that the read BS includes one or more errors. The uncorrectable error component 220 can determine that a portion (e.g., an individual block and/or page within a block) includes uncorrectable errors. These uncorrectable errors can include errors that RAIN is unsuccessful in repairing and/or errors that turbo RAIN fails to successfully recover. In such cases, the uncorrectable error component 220 can selectively mark the portion of the BS as a bad block or bad portion. In some cases, the uncorrectable error component 220 can mark the individual portion as a bad portion in response to the uncorrectable error component 220 determining that the uncorrectable errors resulted from extrinsic defects of the memory device 130. In some cases, the uncorrectable error component 220 can mark the individual portion as a bad portion in response to the uncorrectable error component 220 determining that the uncorrectable errors did not result from extrinsic defects of the memory device 130 but are associated with having a relatively high BEC (e.g., a median or mean BEC of passing portions of the BS that transgresses a threshold BEC value) and in which the CFBit distribution of different storage levels of the portion fail to correspond to an expected CFBit distribution.

For example, the uncorrectable error component 220 can communicate the BS including the passing portions (e.g., the set of portions that were successfully recovered by the data recovery operations) and the failed portion (e.g., the portion with the uncorrectable error) to the defect type detection component 222. The defect type detection component 222 can process the BS to determine whether the uncorrectable error resulted from an extrinsic defect of the memory device 130 (e.g., a portion of the memory device 130 that includes physical defects) or whether the uncorrectable error resulted from some environmental condition, such as HTDR and/or XTEMP condition. The defect type detection component 222 can communicate this determination to the selective block retirement component 224, which can then selectively mark the portion as bad. In cases where the selective block retirement component 224 marks the portion as bad, subsequent write commands can be prevented from being performed on the portion to avoid introducing read errors.

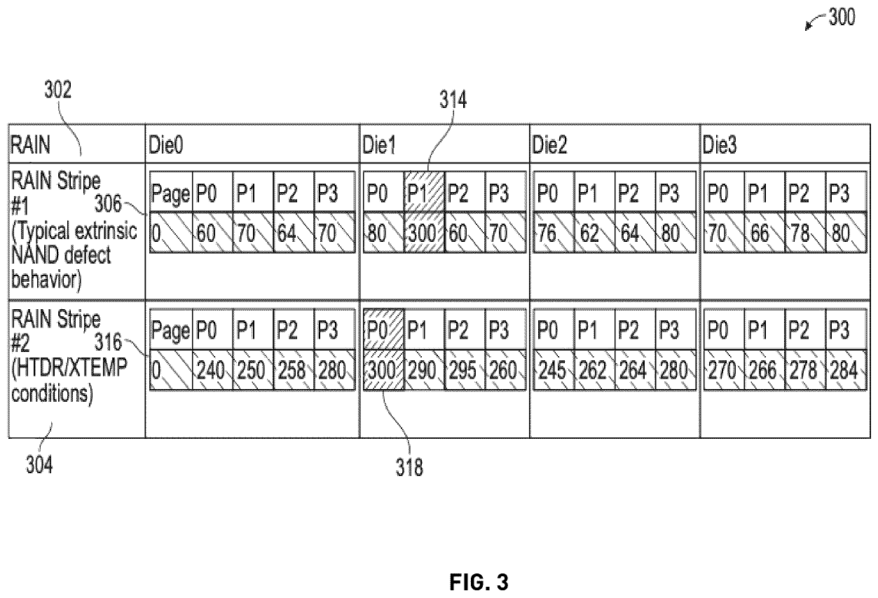

In some cases, the defect type detection component 222 can compute and/or obtain BEC values of each portion of the BS that passed the data recovery operations. For example, as shown in diagram 300 of FIG. 3, the defect type detection component 222 can receive the first BS 302. The defect type detection component 222 can obtain or compute the BEC 306 of each portion of the first BS 302 that was successfully recovered, such as the pages stored in memory die 0 on planes 0-3, the pages stored in memory die 1 on planes 0, 2 and 3 (plane 1 of the memory die 1 (e.g., the first portion 314) includes the uncorrectable error and is excluded from being used in obtaining the BEC 306), the pages stored in memory die 2 on planes 0-3, and the pages stored in memory die 3 on planes 0-3. The defect type detection component 222 can compute a statistical measure of the obtained BEC 306. For example, the defect type detection component 222 can compute a mean or median of the obtained BEC 306.

In some examples, the defect type detection component 222 can determine that the computed statistical measure fails to transgress a specified threshold statistical measure. Namely, the defect type detection component 222 can access a configuration file to obtain the threshold statistical measure that is used to control whether uncorrectable errors in a portion correspond to an extrinsic defect of the memory device 130. The defect type detection component 222, in response to determining that the statistical measure fails to transgress the specified threshold statistical measure (e.g., if the median fails to exceed the threshold median of the BEC of the memory device 130), can determine that the type of defect encountered that caused the uncorrectable errors in the first portion 314 corresponds to an extrinsic defect. The defect type detection component 222 can provide this information to the selective block retirement component 224. The selective block retirement component 224 can then mark the first portion 314 as a bad block in response to determining that the type of defect encountered that caused the uncorrectable errors in the first portion 314 corresponds to the extrinsic defect.

In some examples, the defect type detection component 222 can receive a second BS 304 from the uncorrectable error component 220 that includes one or more uncorrectable errors. The defect type detection component 222 can obtain or compute a BEC 316 of each portion of the second BS 304 that was successfully recovered, such as the pages stored in memory die 0 on planes 0-3, the pages stored in memory die 1 on planes 1, 2 and 3 (plane 0 of the memory die 1 (e.g., the second portion 318) includes the uncorrectable error and is excluded from being used in obtaining the BEC 316), the pages stored in memory die 2 on planes 0-3, and the pages stored in memory die 3 on planes 0-3. The defect type detection component 222 can compute a statistical measure of the obtained BEC 316. For example, the defect type detection component 222 can compute a mean or median of the obtained BEC 316.

In some examples, the defect type detection component 222 can determine that the computed statistical measure transgresses the specified threshold statistical measure. Namely, the defect type detection component 222 can access a configuration file to obtain the threshold statistical measure that is used to control whether uncorrectable errors in a portion correspond to an extrinsic defect of the memory device 130. The defect type detection component 222, in response to determining that the statistical measure (computed based on the BEC 316) transgresses the specified threshold statistical measure (e.g., if the median exceeds the threshold median of the BEC of the memory device 130), can determine that the type of defect encountered in the second BS 304 that caused the uncorrectable errors in the second portion 318 may correspond to an intrinsic defect. For example, the defect type detection component 222 can determine that the uncorrectable error in the second portion 318 may have resulted from some environmental condition, such as HTDR and/or XTEMP condition. In such cases, the defect type detection component 222 can further analyze the second portion 318 before marking the second portion 318 as a bad block.

For example, in response to determining that the uncorrectable errors in the second portion 318 may have resulted from some environmental condition, the defect type detection component 222 can determine whether a CFBit distribution of the second portion 318 (and/or other portions of the second BS 304) correspond to an expected CFBit distribution. To do so, the defect type detection component 222 can obtain a first CFbit value associated with a first storage level (e.g., a lower page of a TLC/QLC storage block of the second portion 318) and can compute a first distribution value based on the first CFbit value, the first storage level, and a total number of bits distributed in the at least the portion of the second BS 304. Specifically, the first CFbit distribution value can be computed in accordance with the following equation: (CFbit*L_x)/(total bits of the distribution), where CFBit corresponds to the first CFBit value obtained by applying a first threshold voltage to read bits stored in the second portion 318, L_x corresponds to the storage level, and the total bits of the distribution is a constant value representing the total number of bits that can be stored across all of the storage levels. The defect type detection component 222 can similarly obtain a second CFbit value associated with a second storage level (e.g., an extra page of a TLC/QLC storage block of the second portion 318) and compute a second distribution value based on the second CFbit value, the second storage level, and the total number of bits distributed in the at least the portion of the second BS 304, such as using the same equation. Each of the different storage levels can correspond to a different threshold voltage applied to the portion of the BS to read data stored in the portion of the BS.

The defect type detection component 222 can then generate a plot (CFBit distribution value being on the y-axis and the storage level being on the x-axis) including a line drawn through each of the computed distribution values, such as the first and second distribution values relative to their corresponding storage levels. The defect type detection component 222 can then obtain a specified or expected plot. The defect type detection component 222 can compare the generated plot of the CFBit distribution values with the specified or expected plot. The defect type detection component 222 can determine whether the generated plot overlaps or resembles or otherwise corresponds or is similar to the specified or expected plot within a specified threshold amount of deviation.

In response to determining that the generated plot overlaps or resembles or otherwise corresponds or is similar to the specified or expected plot within the specified threshold amount of deviation, the defect type detection component 222 determines that the uncorrectable errors in the second portion 318 have resulted from some environmental condition. In such cases, the defect type detection component 222 provides this indication to the selective block retirement component 224 which can prevent marking the portion as a bad block (e.g., preventing marking the plane, second portion 318 of the memory die 1 as a bad block). In response to determining that the generated plot fails to overlap or resemble or otherwise correspond to the specified or expected plot within the specified threshold amount of deviation, the defect type detection component 222 determines that the uncorrectable errors in the second portion 318 have resulted from extrinsic defects of the memory device 130. In such cases, the defect type detection component 222 provides this indication to the selective block retirement component 224, which can mark the portion as a bad block (e.g., marking the plane, second portion 318 of the memory die 1 as a bad block to prevent subsequent write operations from being performed on the second portion 318).

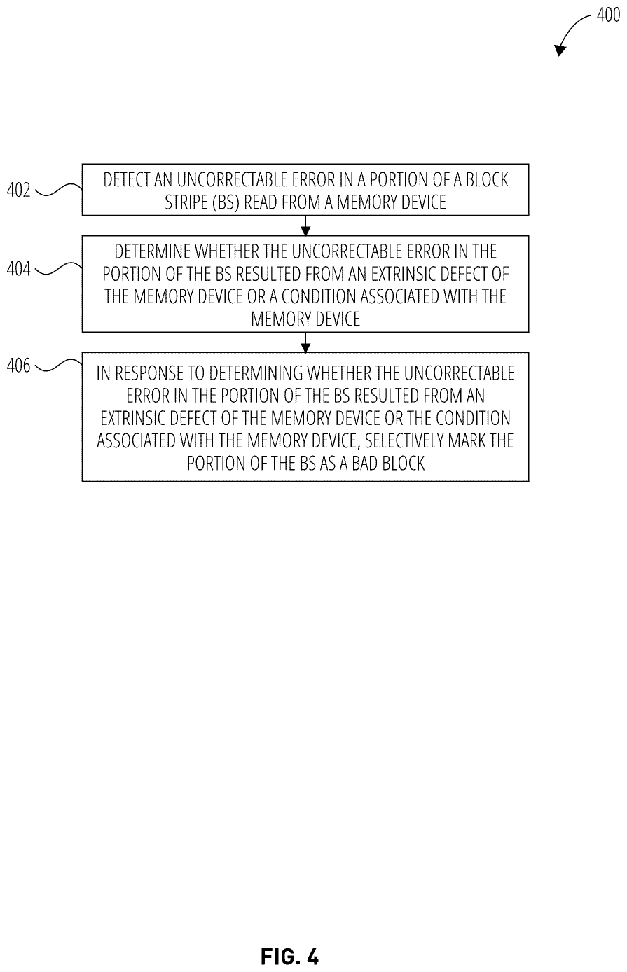

FIG. 4 is a flow diagram of an example method 400 (or process) to identify bad blocks, in accordance with some examples. Method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 400 is performed by the memory sub-system controller 115 or subcomponents of the memory sub-system controller 115 of FIG. 1. In these examples, the method 400 can be performed, at least in part, by the bad block identification component 113. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example. Other process flows are possible.

Referring now to FIG. 4, the method 400 begin at operation 402, with the bad block identification component 113 of a memory sub-system 110 (e.g., memory device 140) detecting an uncorrectable error in a portion of a BS read from a memory device 130. At operation 404, the bad block identification component 113 determines whether the uncorrectable error in the portion of the BS resulted from an extrinsic defect of the memory device 130 or a condition associated with the memory device 130. Then, at operation 406, the bad block identification component 113, in response to determining whether the uncorrectable error in the portion of the BS resulted from an extrinsic defect of the memory device or the condition associated with the memory device 130, selectively marks the portion of the BS as a bad block.

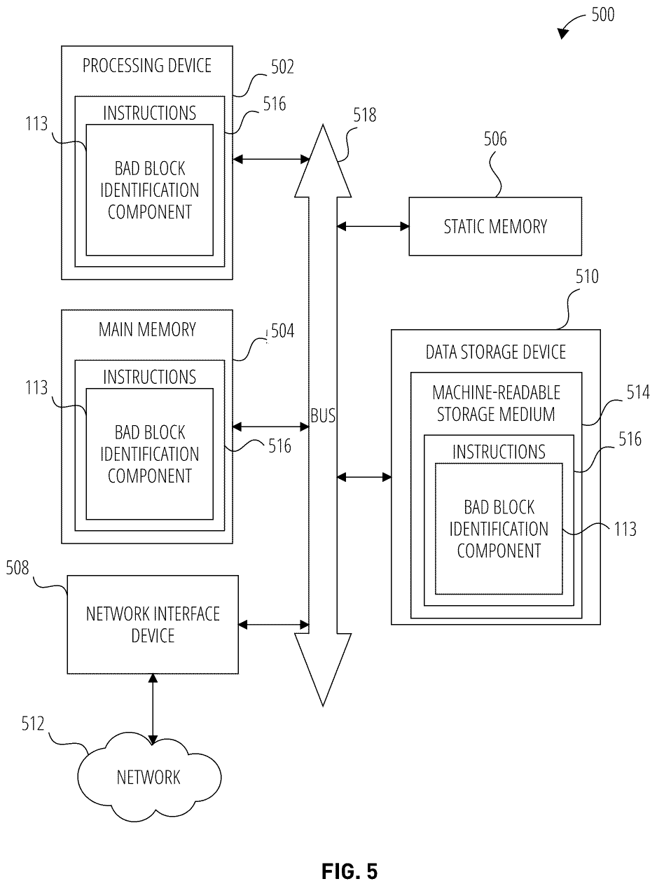

FIG. 5 illustrates an example machine in the form of a computer system 500 within which a set of instructions can be executed for causing the machine to perform any one or more of the methodologies discussed herein. In some examples, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., ROM, flash memory, DRAM such as SDRAM or Rambus DRAM (RDRAM), etc.), a static memory 506 (e.g., flash memory, static random access memory (SRAM), etc.), and a data storage device 510, which communicate with each other via a bus 518.

The processing device 502 represents one or more general-purpose processing devices such as a microprocessor, a central processing unit, or the like. More particularly, the processing device 502 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 502 can also be one or more special-purpose processing devices such as an application-specific integrated circuit (ASIC), a field programmable gate array (FPGA), a digital signal processor (DSP), a network processor, or the like. The processing device 502 is configured to execute instructions 516 for performing the operations and steps discussed herein. The computer system 500 can further include a network interface device 508 to communicate over a network 512.

The data storage device 510 can include a machine-readable storage medium 514 (also known as a computer-readable medium) on which is stored one or more sets of instructions 516 or software embodying any one or more of the methodologies or functions described herein. The instructions 516 can also reside, completely or at least partially, within the main memory 504 and/or within the processing device 502 during execution thereof by the computer system 500, the main memory 504 and the processing device 502 also constituting machine-readable storage media. The machine-readable storage medium 514, data storage device 510, and/or main memory 504 can correspond to the memory sub-system 110 of FIG. 1.

In one example, the instructions 516 include instructions to implement functionality corresponding to providing block failure protection for a zone memory sub-system as described herein (e.g., the bad block identification component 113 of FIG. 1). While the machine-readable storage medium 514 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1. A system comprising: a memory device; and a processing device, operatively coupled to the memory device, configured to perform operations comprising: detecting an uncorrectable error in a portion of a block stripe (BS) read from the memory device; determining whether the uncorrectable error in the portion of the BS resulted from an extrinsic defect of the memory device or a condition associated with the memory device; and in response to determining whether the uncorrectable error in the portion of the BS resulted from an extrinsic defect of the memory device or the condition associated with the memory device, selectively marking the portion of the BS as a bad block.

Example 2. The system of Example 1, wherein the portion comprises an individual block of a plurality of blocks of the BS.

Example 3. The system of any one of Examples 1-2, the operations comprising: determining that the uncorrectable error in the portion resulted from the extrinsic defect of the memory device; and in response to determining that the uncorrectable error in the portion resulted from the extrinsic defect of the memory device, marking the portion of the BS as the bad block to prevent subsequently received write operations from being performed on the portion of the BS.

Example 4. The system of any one of Examples 1-3, the operations comprising: determining that the uncorrectable error in the portion resulted from the condition associated with the memory device; and in response to determining that the uncorrectable error in the portion resulted from the condition associated with the memory device, preventing marking the portion of the BS as the bad block to allow subsequently received write operations to be performed on the portion of the BS.

Example 5. The system of any one of Examples 1-4, wherein the condition comprises exposure of the memory device to a temperature that transgresses a threshold operating temperature of the memory device.

Example 6. The system of any one of Examples 1-5, the operations comprising: receiving a request to read the BS from the memory device; in response to receiving the request to read the BS from the memory device, detecting one or more errors in the BS; and performing a data recovery process to correct the one or more errors in the BS.

Example 7. The system of Example 6, the operations comprising: detecting the uncorrectable portion in response to the data recovery process.

Example 8. The system of Example 7, wherein the data recovery process comprises a RAIN operation.

Example 9. The system of any one of Examples 7-8, the operations comprising: identifying a set of portions of the BS that passed the data recovery process; obtaining a bit error count (BEC) for each portion in the set of portions of the BS; and computing a statistical measure of the obtained BEC of each portion in the set of portions of the BS.

Example 10. The system of Example 9, wherein the statistical measure comprises a mean or median.

Example 11. The system of any one of Examples 9-10, the operations comprising: comparing the statistical measure to a threshold value; and in response to determining that the statistical measure fails to transgress the threshold value, marking the portion comprising the uncorrectable error as the bad block.

Example 12. The system of any one of Examples 9-11, the operations comprising: comparing the statistical measure to a threshold value; and in response to determining that the statistical measure transgresses the threshold value, determining whether to prevent the portion from being marked as the bad block.

Example 13. The system of Example 12, wherein the portion is prevented from being marked as the bad block in response to checking a distribution of programmed bits of information in at least the portion.

Example 14. The system of Example 13, the operations comprising: obtaining CFBit values associated with different storage levels of the at least the portion of the BS; and determining whether each of the obtained CFBit values is evenly distributed.

Example 15. The system of Example 14, the operations comprising: in response to determining that each of the obtained CFBit values is evenly distributed, preventing the portion of the BS from being marked as the bad block.

Example 16. The system of any one of Examples 14-15, the operations comprising: in response to determining that each of the obtained CFBit values is unevenly distributed, marking the portion of the BS as the bad block.

Example 17. The system of any one of Examples 14-16, the operations comprising: obtaining a first CFbit value associated with a first storage level; computing a first distribution value based on the first CFbit value, the first storage level, and a total number of bits distributed in the at least the portion of the BS; obtaining a second CFbit value associated with a second storage level; computing a second distribution value based on the second CFbit value, the second storage level, and the total number of bits distributed in the at least the portion of the BS; determining whether a plot of the first and second distribution values corresponds to an expected plot; and in response to determining that the plot of the first and second distribution values corresponds to the expected plot, preventing the portion of the BS from being marked as the bad block.

Example 18. The system of Example 17, wherein each of the different storage levels corresponds to a different threshold voltage applied to the portion of the BS to read data stored in the portion of the BS.

Example 19. At least one non-transitory machine-readable storage medium comprising instructions that, when executed by a processing device, cause the processing device to perform operations comprising: detecting an uncorrectable error in a portion of a block stripe (BS) read from a memory device; determining whether the uncorrectable error in the portion of the BS resulted from an extrinsic defect of the memory device or a condition associated with the memory device; and in response to determining whether the uncorrectable error in the portion of the BS resulted from an extrinsic defect of the memory device or the condition associated with the memory device, selectively marking the portion of the BS as a bad block.

Example 20. A method comprising: detecting an uncorrectable error in a portion of a block stripe (BS) read from a memory device; determining whether the uncorrectable error in the portion of the BS resulted from an extrinsic defect of the memory device or a condition associated with the memory device; and in response to determining whether the uncorrectable error in the portion of the BS resulted from an extrinsic defect of the memory device or the condition associated with the memory device, selectively marking the portion of the BS as a bad block.

“CFbit” refers to a count of a total quantity of ‘1’s that are stored or represented by an individual read level of a portion, such as a memory block, of the memory device. The CFBit count can be cumulative such that read levels associated with higher read voltages have a higher CFBit count than read levels associated with lower read voltages. Namely, the memory device can generate a total CFBit count and divide that total CFBit count by the total number of read levels that can be used to stored data in the memory device. A first CFBit count can be obtained by reading a quantity of ‘1’s (or alternatively ‘0’s) stored at a first read level and a second CFBit count can be obtained by reading a quantity of ‘1’s (or alternatively ‘0’s) stored at a second read level (which can be adjacent to the first read level). The second read level can be associated with a higher voltage than the first read level and, as a result, the CFBit count of the second read level includes the first CFBit count (e.g., the CFBit count of the first read level) and the CFBit count of the second read level. These CFBit counts can be used to determine a CoV and identify, based on the CoV, a read level for reading data from a given level of the memory device.

The term “coupled with” generally refers to a connection between components, which can be an indirect communicative connection or direct communicative connection (e.g., without intervening components), whether wired or wireless, including connections such as electrical, optical, magnetic, and the like.

“System data” hereinafter refers to data that is created and/or maintained by the memory sub-system for performing operations in response to host requests and for media management.

“User data” hereinafter generally refers to host data and garbage collection data.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, examples of the disclosure have been described with reference to specific examples thereof. It will be evident that various modifications can be made thereto without departing from the broader spirit and scope of examples of the disclosure as set forth in the following claims. The specification and drawings are, accordingly, to be regarded in an illustrative sense rather than a restrictive sense.

1. A system comprising:
a memory device; and
a processing device, operatively coupled to the memory device, configured programmed to perform operations comprising:
receiving a request to read a portion of a block stripe (BS) from the memory device;
detecting an uncorrectable error in the portion read from the memory device;
determining whether the uncorrectable error in the portion of the BS resulted from a physical defect of the memory device or an operational temperature condition affecting the memory device;
based on the request to read the portion of the BS from the memory device and based on determining that the uncorrectable error resulted from the physical defect, marking the portion of the BS as a bad block and based on determining that the uncorrectable error resulted from the operational temperature condition affecting the memory device, preventing marking the portion of the BS as the bad block, the preventing marking of the portion of the BS as the bad block comprising:
computing a first distribution value based on a first count of asserted bit values of a first storage level;
computing a second distribution value based on a second count of asserted bit values of a second storage level;
determining whether the first and second distribution values correspond to an expected distribution; and
preventing the portion of the BS from being marked as the bad block when the first and second distribution values correspond to the expected distribution.

2. The system of claim 1, wherein the portion comprises an individual block of a plurality of blocks of the BS, wherein the portion of the BS is prevented from being marked as the bad block based on determining that the uncorrectable error resulted from an operational temperature of the memory device transgressing a threshold operating temperature.

3. -4. (canceled)

5. The system of claim 1, wherein the operations further comprise determining exposure of the memory device to a temperature that transgresses a threshold operating temperature of the memory device.

6. The system of claim 1, the operations further comprising:
receiving a request to read the BS from the memory device;
in response to receiving the request to read the BS from the memory device, detecting one or more errors in the BS; and
performing a data recovery process to correct the one or more errors in the BS.

7. The system of claim 6, the operations further comprising:
detecting the uncorrectable error in response to the data recovery process.

8. The system of claim 7, wherein the data recovery process comprises a Redundant Array of Independent NAND (RAIN) operation.

9. The system of claim 7, the operations further comprising:
identifying a set of portions of the BS that passed the data recovery process;
obtaining a bit error count (BEC) for each portion in the set of portions of the BS; and
computing a statistical measure of the obtained BEC of each portion in the set of portions of the BS.

10. The system of claim 9, wherein the statistical measure comprises a mean or median.

11. The system of claim 9, the operations further comprising:
comparing the statistical measure to a threshold value; and
in response to determining that the statistical measure fails to transgress the threshold value, marking the portion comprising the uncorrectable error as the bad block.

12. The system of claim 9, the operations further comprising:
comparing the statistical measure to a threshold value; and
in response to determining that the statistical measure transgresses the threshold value, determining whether to prevent the portion from being marked as the bad block.

13. The system of claim 12, wherein the portion is prevented from being marked as the bad block in response to checking a distribution of programmed bits of information in at least the portion.

14. The system of claim 13, the operations further comprising:
obtaining a count of asserted bit values associated with different storage levels of the at least the portion of the BS;
computing distribution values based on the obtained count of asserted bit values, the different storage levels, and a total number of bits distributed in the at least the portion of the BS; and
determining whether the computed distribution values correspond to an expected distribution.

15. The system of claim 14, the operations further comprising:
in response to determining that each of the obtained count of asserted bit values correspond to the expected distribution, preventing the portion of the BS from being marked as the bad block.

16. The system of claim 14, the operations further comprising:
in response to determining that each of the obtained count of asserted bit values fails to correspond to the expected distribution, marking the portion of the BS as the bad block.

17. The system of claim 1, the operations further comprising:
computing the second distribution value based on the second count of asserted bit values, the second storage level, and a total number of bits distributed in the at least the portion of the BS.

18. The system of claim 14, wherein each of the different storage levels corresponds to a different threshold voltage applied to the portion of the BS to read data stored in the portion of the BS.

19. At least one non-transitory machine-readable storage medium comprising instructions that, when executed by a processing device, cause the processing device to perform operations comprising:
receiving a request to read a portion of a block stripe (BS) from a memory device;
detecting an uncorrectable error in the portion read from the memory device;
determining whether the uncorrectable error in the portion of the BS resulted from a physical defect of the memory device or an operational temperature condition affecting the memory device;
based on the request to read the portion of the BS from the memory device and based on determining that the uncorrectable error resulted from the physical defect, marking the portion of the BS as a bad block and based on determining that the uncorrectable error resulted from the operational temperature condition affecting the memory device, preventing marking the portion of the BS as the bad block, the preventing marking of the portion of the BS as the bad block comprising:
computing a first distribution value based on a first count of asserted bit values of a first storage level;
computing a second distribution value based on a second count of asserted bit values of a second storage level:
determining whether the first and second distribution values correspond to an expected distribution: and
preventing the portion of the BS from being marked as the bad block when the first and second distribution values correspond to the expected distribution.

20. A method comprising:
receiving a request to read a portion of a block stripe (BS) from a memory device;
detecting an uncorrectable error in the portion read from the memory device;
determining whether the uncorrectable error in the portion of the BS resulted from a physical defect of the memory device or an operational temperature condition affecting the memory device;
based on the request to read the portion of the BS from the memory device and based on determining that the uncorrectable error resulted from the physical defect, marking the portion of the BS as a bad block and based on determining that the uncorrectable error resulted from the operational temperature condition affecting the memory device, preventing marking the portion of the BS as the bad block, the preventing marking of the portion of the BS as the bad block comprising:
computing a first distribution value based on a first count of asserted bit values of a first storage level;
computing a second distribution value based on a second count of asserted bit values of a second storage level;
determining whether the first and second distribution values correspond to an expected distribution; and
preventing the portion of the BS from being marked as the bad block when the first and second distribution values correspond to the expected distribution.

21. (canceled)

22. The method of claim 20, wherein each of the first and second storage levels corresponds to a different threshold voltage applied to the portion of the BS to read data stored in the portion of the BS.

23. The method of claim 20, wherein the portion comprises an individual block of a plurality of blocks of the BS, wherein the portion of the BS is prevented from being marked as the bad block based on determining that the uncorrectable error resulted from an operational temperature of the memory device transgressing a threshold operating temperature.
